(19) United States
(12) Patent Application Publication
(10) Pub. No.: US 2013/0266802 A1
(43) Pub. Date: Oct. 10, 2013

(54) CATALYST CERAMIC SUPPORT HAVING A CONTROLLED MICROSTRUCTURE

(71) Applicants: Pascal Del-Gallo, Dourdan (FR); Fabrice Rossignol, Verneuil Sur Vienne (FR); Thierry Chartier, Feytiat (FR); Claire Bonhomme, Panazol (FR); Raphael Faure, Villebon-Sur-Yvette (FR); Sebastien Goudalle, Limoges (FR)

(72) Inventors: Pascal Del-Gallo, Dourdan (FR); Fabrice Rossignol, Verneuil Sur Vienne (FR); Thierry Chartier, Feytiat (FR); Claire Bonhomme, Panazol (FR); Raphael Faure, Villebon-Sur-Yvette (FR); Sebastien Goudalle, Limoges (FR)

(73) Assignees: L'Air Liquide Societe Anonyme Pour L"Etude Et L"Exploitation Des Procedes Georges Claude, Paris (FR); Centre National De La Recherche Scientifique - France; Universite De Limoges

(21) Appl. No.: 13/994,452

(22) PCT Filed: Dec. 14, 2011
(86) PCT No.: PCT/FR2011/052973

§ 371 Date: Jun. 14, 2013

(30) Foreign Application Priority Data
Dec. 16, 2010 (FR) 1060629

(51) Int. Cl. B01J 35/02; B01J 37/02; B01J 37/00; B01J 35/08

(52) U.S. Cl. CPC B01J 35/02; B01J 35/023; B01J 35/08; B01J 37/0201; B01J 37/0072
USPC 428/338; 428/221; 502/439

(57) ABSTRACT

The invention relates to a catalyst support made of a ceramic, the support comprising an arrangement of crystallites having the same size, the same isodiametric morphology and the same chemical composition or substantially the same size, the same isodiametric morphology and the same chemical composition, in which each crystallite makes point contact or almost point contact with the surrounding crystallites.

The present invention relates to a ceramic catalyst support having a controlled microstructure and to a method for its synthesis.

Heterogeneous catalysis is vital to numerous applications in the chemical, food, pharmaceutical, automotive, and petrochemical industries [1-3]. The development of a catalyst support with controlled architecture is part of research into stable materials possessing a maximum specific surface area at both low and high temperatures.

A catalyst is a material which converts reactants to product through repeated and uninterrupted cycles of unit phases. The catalyst participates in the conversion, returning to its original state at the end of each cycle, throughout its lifetime. A catalyst modifies the reaction kinetics without changing the thermodynamics of the reaction.

In order to maximize the degree of conversion of supported catalysts, it is essential to maximize the capacity of the reactants to gain access to the active particles. In order to understand the advantage of a support such as that developed here, it is necessary first to recall the principal steps in a heterogeneous catalysis reaction. A gas composed of molecules A passes through a catalyst bed and reacts at the surface of the catalyst to form a gas of species B.

The unit steps together are as follows:
a) transport of the reactant A (volume diffusion) through a layer of gas to the outer surface of the catalyst
b) diffusion of species A (volume diffusion or molecular (Knudsen) diffusion) through the pore network of the catalyst to the catalytic surface
c) adsorption of species A on the catalytic surface
d) reaction of A to form B at the catalytic sites present on the surface of the catalyst
e) desorption of the product B from the surface
f) diffusion of species B through the pore network
g) transport of the product B (volume diffusion) from the outer surface of the catalyst through the gas layer to the flow of gas.

The number of molecules converted to product with a defined time interval is directly linked to the number of catalytic sites available. It is therefore necessary to maximize the number of available active sites per unit surface area. In order to do this it is necessary to maximize the dispersion of the active particles at the surface of the support. In order to maximize this dispersion, it is necessary to have a support which itself has a maximize specific surface area.

The active species may be one or more transition metals (Fe, Co, Cu, Ni, Ag, Mo, Cr, . . . , NiCo, FeNi, FeCr . . . ) or one or more transition metal oxides (CuO, ZnO, NiO, CoO, NiMoO, CuO—ZnO, FeCrO, . . . ), one or more noble metals (Pt, Pd, Rh, PtRh, PdPt, . . . ) or one or more transition metal oxides (Rh₂O₃, PtO, RhPtO, . . . ), or mixtures of transition metals and noble metals or mixtures of transition oxides and noble metal oxides. In certain reactions the active species may be sulfide compounds (NiS, CoMoS, NiMoS, . . . ). The ideal is to disperse nanometric (<5 nm) active phases on the surface of a ceramic support in general. The smaller the catalyst particle, the greater will be its surface-to-volume ratio and hence the greater will be its developed surface per unit mass (for active phases, the phrase used is MSA: metallic surface area, expressed as surface area per unit mass, such as m²/g of metal, for example; for ceramic catalyst supports, the phrase used is BET surface area and/or pore volume).

A surface will always tend by definition to minimize its energy. The two main barriers to the development of supports having high specific surface areas are as follows:
sintering, a natural phenomenon which occurs at temperature; and
crystalline phase change: a change of phase usually accompanied by destructuring.

These two phenomena are linked to one another and are manifested in a decrease in the specific surface area of the material under consideration. An example is the conversion of γ-alumina to γ-alumina that takes place spontaneously above 1100° C. in air. The specific surface area of a γ-alumina may range up to several hundred m²/g, whereas a standard γ-alumina has a specific surface area of less than ten m²/g.

A number of supports with high specific surface area have already been synthesized.

Silica is the first mesoporous material to have been synthesized, in 1992. On the basis of the evaporation-induced self-assembly method, document US2003/0039744A1 sets out how to obtain a mesoporous silica support.

Crepaldi, E. L., et al., Nanocrystallised titania and zirconia mesoporous thin films exhibiting enhanced thermal stability. New Journal of Chemistry, 2003. 27(1): p. 9-13 and Wong, M. S, and J. Y. Ying, Amphiphilic Templating of Mesostructured Zirconium Oxide. Chemistry of Materials, 1998. 10(8): p. 2067-2077, describe the synthesis of mesoporous zirconia. As for the majority of mesoporous materials, thermal stability is ensured only up to 500° C.-600° C. For higher temperatures, structures collapse through sintering or phase change.

Document CN101565194 (A) describes a method for producing mesoporous MgAl₂O₄ spinel. The resulting MgAl₂O₄ spinel is composed of particles with a diameter of 100 nm and a specific surface area of between 200 and 400 m²/g; the pore diameter is between 3 and 6 nm.

However, these ceramic supports provided by the prior art do not possess good physicochemical stability under the severe operating conditions of the steam reforming of natural gas, in particular at high temperature (600-1000° C.) in a very hydrothermal atmosphere (steam % between 20 and 60 vol %).

Consequently, one problem which arises is that of providing a ceramic catalyst support possessing good physicochemical stability under severe operating conditions.

One solution of the invention is a ceramic catalyst support comprising an arrangement of crystallites of equal size, equal isodiametric morphology, and equal chemical composition, or of substantially equal size, equal isodiametric morphology and equal chemical composition, in which each crystallite is in point or quasi-point contact with surrounding crystallites.

In the context of the present invention, a crystallite is a domain of matter having the same structure as a monocrystal.

In other words, the present invention relates to the stabilization of the ceramic catalyst support used as a support for one or more active phases, via the creation of a microstructure composed of an ordered and structured system, allowing minimization of the physical aging phenomena associated primarily with the temperature and with the accompanying gaseous atmospheres.

It should be noted that the ceramic catalyst support according to the invention has the first advantage of developing a high available specific surface area, typically of greater than or equal to 50 m²/g and up to several hundred m²/g. Moreover, said support is stable in terms of specific surface area at least up to 1000° C. under a hydrothermal atmosphere.

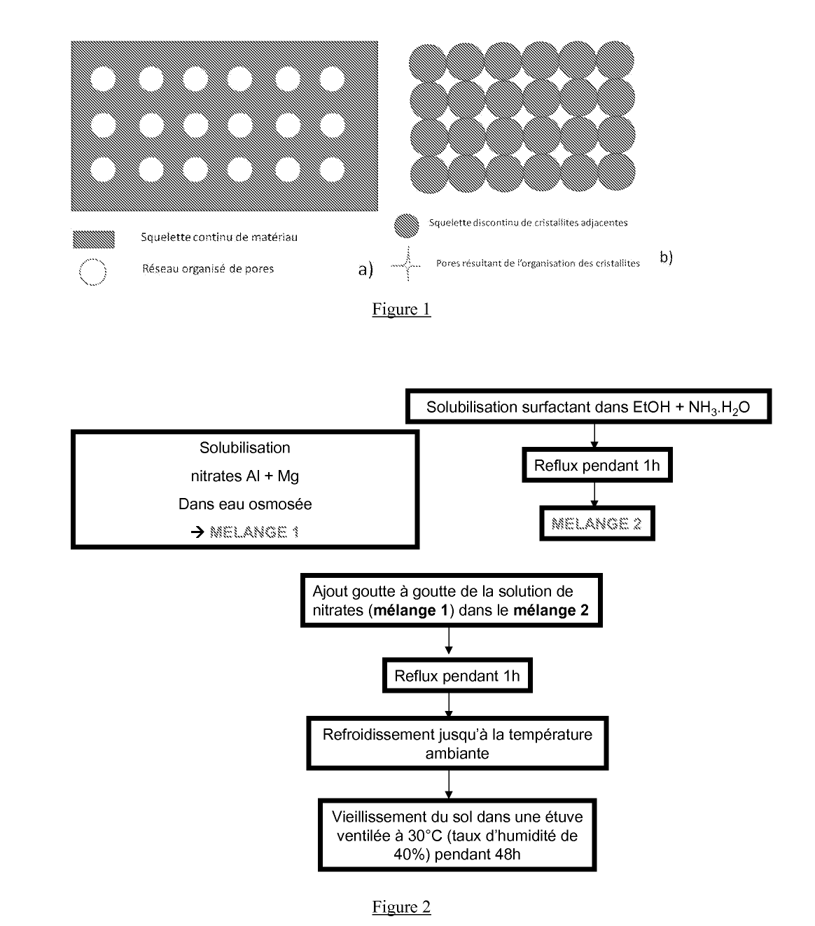

FIG. 1a) represents, schematically, a prior-art catalyst support. More specifically it comprises a mesoporous structure.

FIG. 1b) represents, schematically, a catalytic support according to the invention. In this figure, each crystallite is in contact with 6 other crystallites in one plane (i.e., close-packed stacking).

The size of the pores resulting from the arrangement of the catalyst support according to the invention is typically between 5 and 15 nm.

Where appropriate, the ceramic catalyst support according to the invention may feature one or more of the characteristics below:
the arrangement of crystallites is a face-centered cubic or close-packed hexagonal stack in which each crystallite is in point or quasi-point contact with not more than 12 other crystallites in a 3-dimensional space;
said arrangement is in spinel phase; by spinel phase is meant, for example, the compound MgAl₂O₄;
the crystallites are substantially spherical in shape;
the crystallites have a mean equivalent diameter of between 5 and 15 nm, preferably between 11 and 14 nm; by equivalent diameter is meant the greatest length of the crystallite if the latter is not strictly spherical;
said support comprises a substrate and a film on the surface of said substrate comprising said arrangement of crystallites;
said support comprises granules comprising said arrangement of crystallites;
the granules are substantially spherical in shape.

As well as an arrangement in spinel phase, it is possible to have an arrangement in the following ceramic phases: SiC, ZrO2, ZrO₂ stabilized with yttrium oxide, such as YSZ (4 and 8-10%), CeO₂, CeO₂ stabilized with gadolinium oxide, conventional alumina, silico-aluminous compounds, etc.

It is noteworthy that the ceramic catalyst support according to the invention can be used for any heterogeneous catalysis reaction, more particularly a gas-solid reaction, and may be applied (wash coated) to a ceramic and/or metallic substrate in a variety of architectures such as cellular structures, barrels, monoliths, honeycomb structures, spheres, multiscale structured reactor-exchangers (veactors), etc., which are ceramic or metallic or metallic coated with ceramic (monolith, honeycomb, sphere, rod, powder, etc.).

The present invention likewise provides a first method for synthesizing a ceramic catalyst support comprising a substrate and a film on the surface of said substrate, comprising an arrangement of crystallites with the same size, same isodiametric morphology, and same chemical composition or substantially the same size, same isodiametric morphology, and same chemical composition, in which each crystallite is in point or quasi-point contact with its surrounding crystallites, wherein the following steps are carried out:
a) preparing a sol comprising magnesium nitrate and aluminum nitrate salts, a surfactant, and the solvents water, ethanol, and aqueous ammonia;
b) immersing a substrate in the sol prepared in step a);
c) drying the substrate impregnated with sol, to give a gelled composite material comprising a substrate and a gelled matrix; and
d) calcining the gelled composite material from step c) at a temperature greater than 700° C. and less than or equal to 1100° C., preferably greater than or equal to 800° C., more particularly less than or equal to 1000° C., even more preferably at a temperature greater than or equal to 850° C. and less than or equal to 950° C.

The substrate employed in this first synthesis method is preferably made of dense alumina.

The present invention likewise provides a second method for synthesizing a ceramic catalyst support comprising granules comprising an arrangement of crystallites of the same size, same isodiametric morphology, and same chemical composition or substantially the same size, same isodiametric morphology, and same chemical composition, in which each crystallite is in point or quasi-point contact with its surrounding crystallites, wherein the following steps are carried out:
e) preparing a sol comprising magnesium nitrate and aluminum nitrate salts, a surfactant, and the solvents water, ethanol, and aqueous ammonia;
f) spraying the sol in contact with a stream of hot air, so as to evaporate the solvent and form a micrometer-size powder;
g) calcining the powder at a temperature of greater than 700° C. and less than or equal to 1100° C., preferably greater than or equal to 800° C., more particularly less than or equal to 1000° C., even more preferably at a temperature greater than or equal to 850° C. and less than or equal to 950° C.

The two synthesis methods according to the invention may feature one or more of the characteristics below:
the sol prepared in step a) is aged in a ventilated oven at a temperature of between 15 and 35° C.
calcining step d) is carried out in air and has a duration of 24 hours.

The sol prepared in the two synthesis methods according to the invention preferably comprises four main constituents:
Inorganic precursors: for reasons of cost limitation, we have chosen to use magnesium nitrate and aluminum nitrate. The stoichiometry of these nitrates can be verified by ICP (Induced Coupled Plasma) before they are dissolved in the osmosed water.
The surface-active agent, also called surfactant, is preferably a nonionic surfactant. Use may be made of a Pluronic F127 EO-PO-EO triblock copolymer. It possesses two hydrophilic blocks (EO) and a central hydrophobic block (PO).
The solvent (absolute ethanol).
NH₃.H₂O (28 mass %). The surfactant is dissolved in an ammoniacal solution, producing hydrogen bonds between the hydrophilic blocks and the inorganic species.

One example of molar ratios of these various constituents is given in the table below (table 1):

| | |
|---|---|
| n_{H2O}/nₙᵢₜᵣₐₜₑ | 111 |
| n_{EtOH}/nₙᵢₜᵣₐₜₑ | 38 |
| n_{F127}/nₙᵢₜᵣₐₜₑ | 6.7 × 10⁻³ |
| n_{F127}/n_{H2O} | 6.0 × 10⁻⁶ |

The process for preparing the sol is described in FIG. 2.

In the paragraph which follows, the amounts in brackets correspond to a single example.

The first step is to dissolve the surfactant (0.9 g) in absolute ethanol (23 ml) and in an ammoniacal solution (4.5 ml). The mixture is subsequently heated at reflux for 1 hour. The solution of nitrates (20 ml), prepared beforehand, is then added dropwise to the mixture. The whole mixture is heated at reflux for 1 hour and then cooled to the ambient temperature. The sol synthesized in this way is aged in a ventilated oven with a precisely controlled ambient temperature (20° C.).

In the case of the first synthesis method, immersion involves dipping a substrate in the sol and withdrawing it at a constant rate. The substrates used in our study are alumina plaques sintered at 1700° C. for 1 hour 30 minutes in air (relative density of the substrates=97% relative to the theoretical density).

During the withdrawal of the substrate, the movement of the substrate causes the liquid to form a surface layer. This layer divides into two, with the inner part moving with the substrate, while the outer part falls back into the vessel. The progressive evaporation of the solvent leads to formation of a film on the surface of the substrate.

The thickness of the coating obtained can be estimated as a function of the viscosity of the sol and the pulling rate (equation 1):

e∞KV^{2/3}

where K is a coating constant which is dependent on the viscosity and the density of the sol and on the liquid-vapor surface tension. The v is the pulling rate. Accordingly, the greater the pulling rate, the greater the thickness of the coating.

The immersed substrates are subsequently oven-treated at between 30° C. and 70° C. for a number of hours. A gel is then formed. Calcining the substrates in air removes the nitrates and also breaks down the surfactant and, consequently, liberates the porosity.

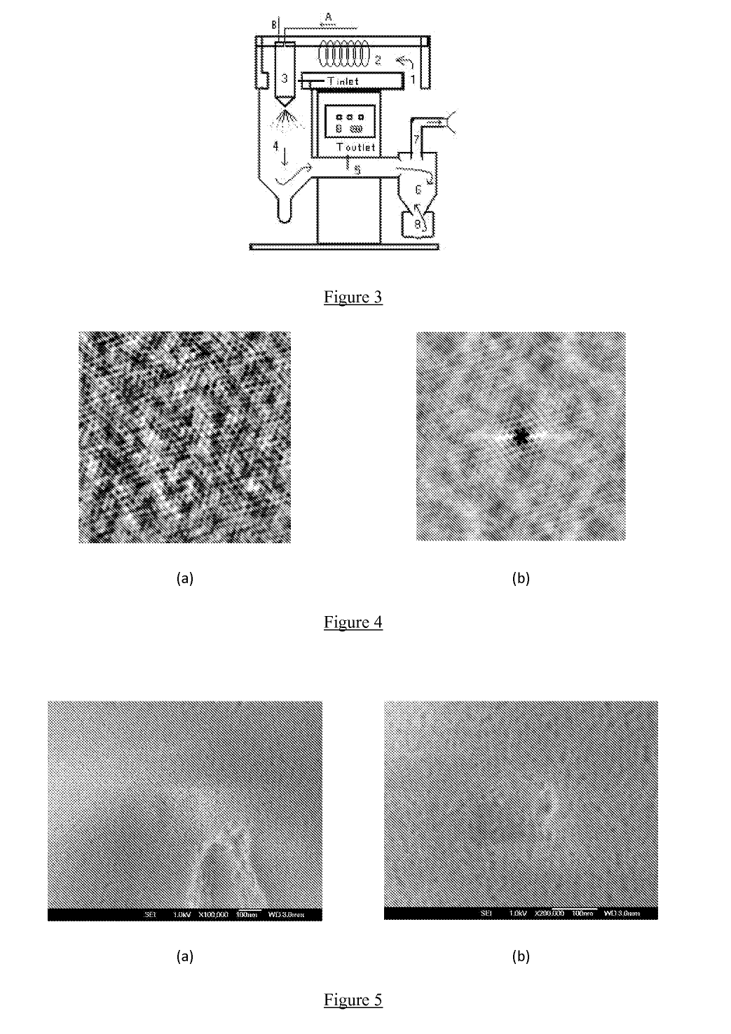

In the case of the second synthesis method, the spraying technique converts a sol into solid dry form (powder) through the use of a hot intermediate (FIG. 3).

The principle lies in the sol 3 being atomized into fine droplets in a chamber 4 in contact with a stream of hot air 2 in order to evaporate the solvent. The resulting powder is driven by the peak flow 5 to a cyclone 6, which will separate the air 7 from the powder 8.

The apparatus which can be used for the purposes of the present invention is a commercial Büchi-brand 190 minispray dryer model.

The powder recovered at the end of spraying is dried in an oven at 70° C. and then calcined.

In both processes, moreover, the precursors, namely the magnesium nitrate and aluminum nitrate salts, are partially hydrolyzed (equation 2). Evaporation of the solvents (ethanol and water) then allows the sol to be crosslinked as a gel around micelles of surfactant for the formation of bonds between the hydroxyl groups of one salt and the metal of another salt (equations 3 and 4)

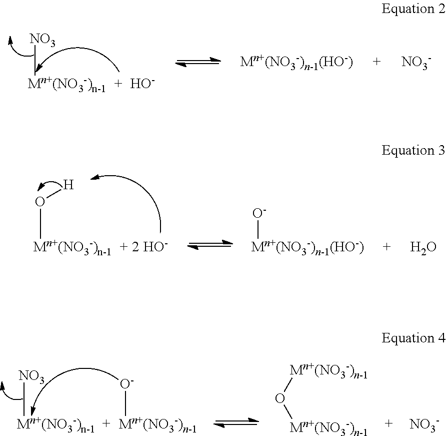

Control of these reactions, which are associated with electrostatic interactions between the inorganic precursors and the surfactant molecules, allows cooperative assembly of the organic and inorganic phases, giving rise to micellar aggregates of surfactants of controlled size within an inorganic matrix.

The reason is that the nonionic surfactants used are copolymers which possess two parts having different polarities: a hydrophobic body, and hydrophilic ends. These copolymers form part of the class of block copolymers consisting of poly(alkylene oxide) chains. One example is the (EO)n-(PO)m-(EO)n copolymer consisting of the concatenation of polyethylene oxide (EO), which is hydrophilic at the ends, and, in its central part, polypropylene oxide (PO), which is hydrophobic. The polymer chains remain dispersed in solution at a concentration lower than the critical micelle concentration (CMC). The CMC is defined as being the limiting concentration beyond which the phenomenon occurs of self-arrangement of the surfactant molecules in the solution. Above this concentration, the chains of the surfactant have a propensity to assemble by virtue of hydrophilic/hydrophobic affinity. Accordingly, the hydrophobic bodies assemble and form micelles with a spherical shape. The polymer chain ends are repelled toward the outside of the micelles, and associate during evaporation of the volatile solvent (ethanol) with the ionic species in solution, which likewise have hydrophilic affinities.

This self-arrangement phenomenon takes place during the drying steps c) of the synthesis methods according to the invention.

The advantages of calcining at a temperature of between 500° C. and 1000° C. are now examined.

In a first stage, the substrate, covered with a thin film, was calcined in air at 500° C. for 4 hours, with a rate of temperature rise of 1° C./min.

The sample is observed using a high-resolution scanning electron microscope (FEG-SEM) and an atomic force microscope (AFM). The atomic force microscope reports the surface topography of a sample with an ideally atomic resolution. The principle consists in scanning the surface of the sample with a point whose end is atomic in dimension, while measuring the forces of interaction between the end of the point and the surface. With the force of interaction kept constant, it is possible to measure the topography of the sample.

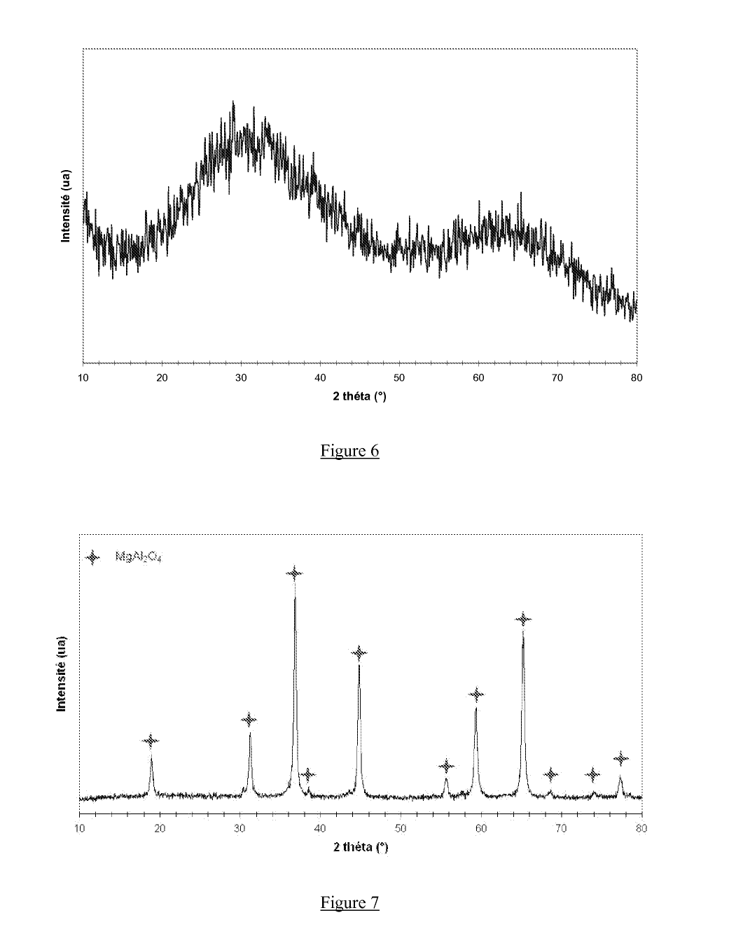

The AFM images carried out over a surface area of 500 nm² (FIG. 4) and also the FEG-SEM micrographs (FIG. 5) reveal the formation of a mesostructured coating at this calcining temperature. FIG. 4(a) is a topography image, while FIG. 4(b) is an autocorrelation image.

The mesostructuring of the material follows a progressive concentration, within the coating, of the aluminum and magnesium precursors, and also of the surfactant, up to a micelle concentration which is greater than the critical concentration, which results from the evaporation of the solvents.

On the other hand, at this calcining temperature (500° C.—4 hours), the spinel phase is not completely formed and the compound is amorphous (FIG. 6). The diffractogram was carried out on the powder obtained by spraying the sol.

This is why we chose to increase the temperature at which the materials were calcined to 900° C.

At this temperature, the spinel phase (MgAl₂O₄) is completely crystallized (FIG. 7).

Calcining at 900° C. destroys the mesostructuring of the coating which was present at 500° C. The crystallization of the spinel phase gives rise to a local disorganization of the porosity. The result, nevertheless, is a ceramic catalyst support according to the invention—in other words, an ultrafinely divided and highly porous coating with quasi spherical particles in point or quasi-point contact with one another (FIG. 8). FIG. 8 corresponds to three FEG-SEM micrographs of the catalyst support with 3 different magnifications.

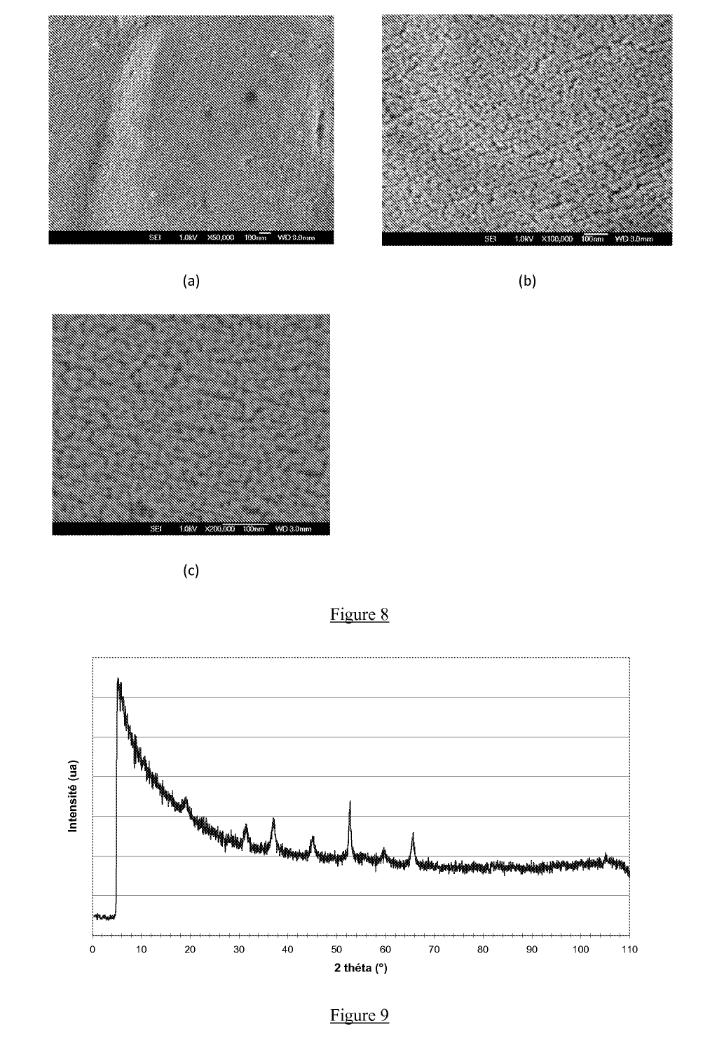

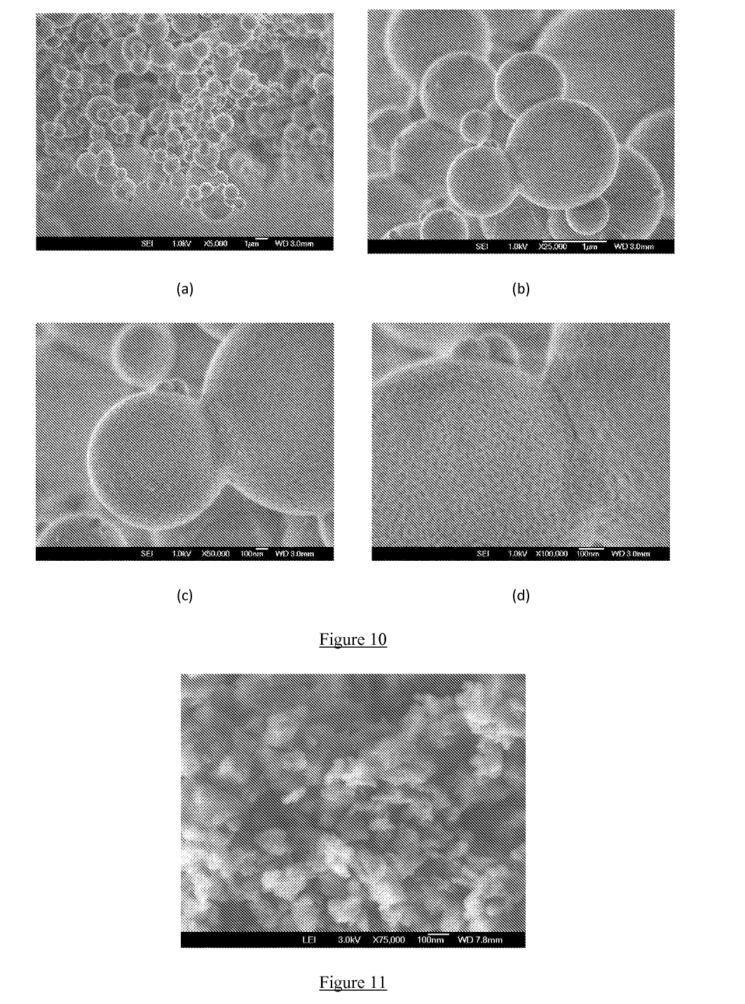

These particles exhibit a very narrow particle size distribution centered on 12 nm (average size of the spinel crystallites, measured by small-angle SR diffraction, FIG. 9). This size corresponds to that of the elementary particles observed in scanning electron microscopy, indicating that the elementary particles are monocrystalline.

Small-angle X-ray diffraction (2θ angle values of between 0.5 and 6°): this technique enabled us to determine the size of the crystallites in the catalyst support. The diffractometer used in this study, based on a Debye-Scherrer geometry, is equipped with a curved locational detector (Inel CPS 120) at the centre of which the sample is positioned. The sample is a monocrystalline sapphire substrate to which the sol has been applied by immersing and drawing. The Scherrer formula connects the width at half-maximum of the diffraction peaks with the size of the crystallites (equation 5).

$$D = 0.9 \times \frac{λ}{β cos θ}$$

D corresponds to the size of the crystallites (nm)
λ is the wavelength of the Kα ray of Cu (1.5406 Å)
β corresponds to the width at half-maximum of the ray (in rad)
θ corresponds to the diffraction angle.

The spraying of the sol, followed by calcining of the powder at 900° C., produces spherical granules with a diameter which is less than 5 μm and is preferably in the range of between 100 nm and 2 μm (FIG. 10). The microstructure of this powder is identical to that obtained on the coating, namely an ultrafinely divided and porous microstructure with a crystallite size of the same order of magnitude.

The specific surface of the powder, measured by the BET method, is 15 m²/g.

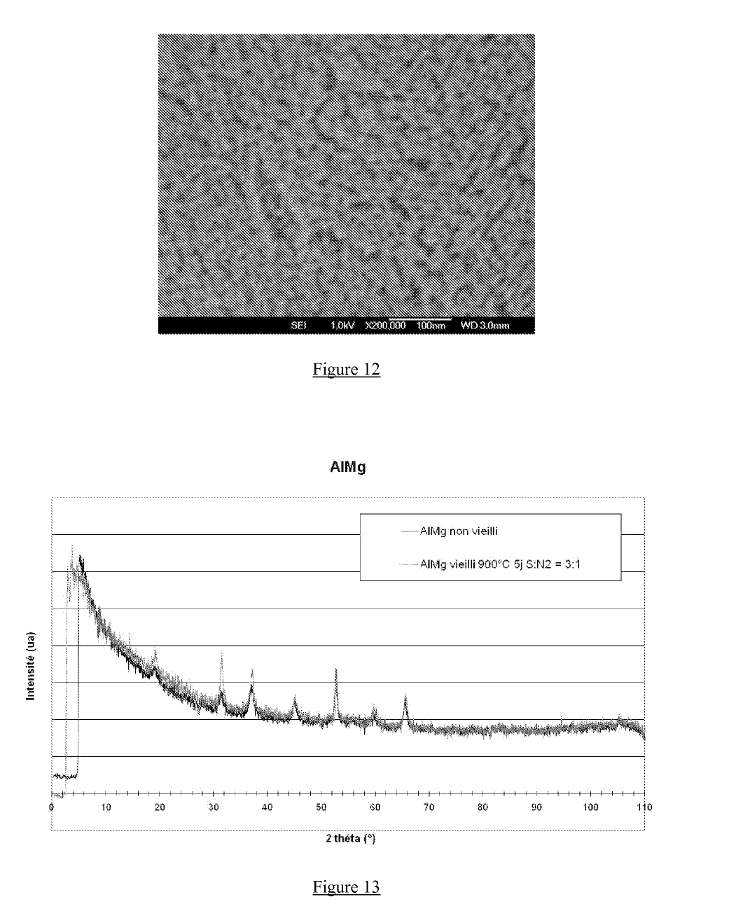

The morphology of the powder was compared with that of a commercial Puralox MG30 spinel-phase powder supplied by Sasol (FIG. 11). This powder has a specific surface area of 30 m²/g.

The particles of the commercial powder are not spherical and their particle size distribution is broad, which will potentially promote enlargement of the particles in the course of aging under hydrothermal conditions.

The ceramic catalyst supports according to the invention, obtained by immersing the sol on a substrate, or, in other words, comprising a substrate and a film, and also the ceramic catalyst supports according to the invention that are obtained by spraying of the sol, or, in other words, comprising granules, were aged under hydrothermal conditions, specifically a temperature of 900° C. for 100 hours under an atmosphere rich in water vapor and nitrogen (the molar ratio of water vapor to nitrogen is 3).

The ultrafinely divided microstructure of the coatings calcined at 900° C. does not change very much during the hydrothermal aging (FIG. 12). The very great uniformity of size, of morphology, and of chemical composition and also the ultrafine division (i.e., limited number of contacts between particles) considerably limit the local gradients in chemical potential that constitute the driving force of the migration of the species responsible for the sintering. The preservation of the particle size was confirmed by the results of small-angle XR diffraction (FIG. 13). Indeed, the size of the elementary monocrystalline particles, as measured by this technique, is 14 nm after aging (gray line). It was 12 nm before aging (black line).

The specific surface area of the aged powder is 41 m²/g, thereby exhibiting a very slight diminution in the specific surface area.

1-14. (canceled)

15. A ceramic catalyst support comprising an arrangement of crystallites of equal size, equal isodiametric morphology, and equal chemical composition, or of substantially equal size, equal isodiametric morphology and equal chemical composition, in which each crystallite is in point or quasi-point contact with surrounding crystallites.

16. The ceramic catalyst support of claim 15, wherein the arrangement of crystallites is a face-centered cubic or hexagonal close-packed stack in which each crystallite is in point or quasi-point contact with not more than 12 other crystallites in a 3-dimensional space.

17. The ceramic catalyst support of claim 15, wherein said arrangement is in spinel phase.

18. The ceramic catalyst support of claim 15, wherein the crystallites are substantially spherical in shape.

19. The ceramic catalyst support of claim 18, wherein the crystallites have a mean equivalent diameter of between 5 and 15 nm, preferably between 11 and 14 nm.

20. The ceramic catalyst support of claim 15, wherein said support comprises a substrate and a film on the surface of said substrate comprising said arrangement of crystallites.

21. The ceramic catalyst support of claim 15, wherein said support comprises granules comprising said arrangement of crystallites.

22. The ceramic catalyst support of claim 21, wherein the granules are substantially spherical in shape.

23. The method for synthesizing a ceramic catalyst support of claim 20, comprising the following steps:
a) preparing a sol comprising magnesium nitrate and aluminum nitrate salts, a surfactant, and the solvents water, ethanol, and aqueous ammonia;
b) immersing a substrate in the sol prepared in step a);
c) drying the substrate impregnated with sol, to give a gelled composite material comprising a substrate and a gelled matrix; and
d) calcining the gelled composite material from step c) at a temperature greater than 700° C. and less than or equal to 1100° C., preferably greater than or equal to 800° C., more particularly less than or equal to 1000° C., even more preferably at a temperature greater than or equal to 850° C. and less than or equal to 950° C.

24. The method for synthesizing of claim 23, wherein the substrate is a substrate made of dense alumina.

25. The method for synthesizing a ceramic catalyst support of claim 21, comprising the following steps:
e) preparing a sol comprising magnesium nitrate and aluminum nitrate salts, a surfactant, and the solvents water, ethanol, and aqueous ammonia;
f) spraying the sol in contact with a stream of hot air, so as to evaporate the solvent and form a micrometer-size powder;
g) calcining the powder at a temperature of greater than 700° C. and less than or equal to 1100° C., preferably greater than or equal to 800° C., more particularly less than or equal to 1000° C., even more preferably at a temperature greater than or equal to 850° C. and less than or equal to 950° C.

26. The method for synthesizing of claim 23, wherein the sol prepared in step a) is aged in a ventilated oven at a temperature of between 15 and 35° C.

27. The method of claim 23, wherein calcining step c) has a duration of 24 hours and is carried out in air.

28. The use of the ceramic support of claim 15 for heterogeneous catalysis.
